(19) United States
(12) Patent Application Publication
(10) Pub. No.: US 2026/0169424 A1
(43) Pub. Date: Jun. 18, 2026

(54) CONVEYING DEVICE AND IMAGE FORMING SYSTEM

(71) Applicant: CANON KABUSHIKI KAISHA, Tokyo (JP)

(72) Inventor: KAZUHIKO AONO, Shizuoka (JP)

(21) Appl. No.: 19/407,843

(22) Filed: Dec. 3, 2025

(30) Foreign Application Priority Data
Dec. 18, 2024 (JP) 2024-222680

(51) Int. Cl. G03G 21/16; G03G 15/00

(52) U.S. Cl. CPC G03G 21/1619; G03G 15/6529; G03G 21/1647; G03G 2221/1654

(57) ABSTRACT

A conveying device for a recording material includes: a first side plate and a second side plate facing each other; and a beam member mounted to them. The first side plate and the beam member are different from each other in plate thickness. One and the other of the first side plate and the beam member include a hole and an insertion portion, respectively. The insertion portion is inserted in the hole that form a positioning portion positioning the first side plate and the beam member in a first direction. The insertion portion includes a widened portion. The widened portion has a first direction width increasing from downstream to upstream in an inserting direction of the insertion portion, and includes a pair of first direction end portions that are in contact with an edge of the hole in the first direction.

### BACKGROUND

### Field of the Technology

The present disclosure relates to a conveying device and an image forming system.

### Description of the Related Art

An image forming apparatus (e.g., a copier, a printer) and a detachable function extension device attached to the image forming apparatus are configured such that functional components are mounted to a frame. Accordingly, it is preferable to enhance solidity of the entire device in order to suppress impact during physical distribution and influence due to unevenness in an installation surface. To enhance the solidity of the entire device, it is desirable to enhance solidity of a frame of the device. Japanese Patent Application Publication No. 2002-214869 discloses an art for enhancing solidity of a frame by employing a high rigidity member with a greater plate thickness as a part of members composing the frame.

In case of a frame composed of plate members where an insertion portion of a first one of the plate members is inserted in a hole of a second member of the plate members to fix relative positioning of the first and second ones, the frame may be deteriorated in solidity due to presence of a gap between the insertion portion and the hole in a positioning portion.

### SUMMARY

The present disclosure intends to enhance solidity of a frame of a conveying device for a recording material or an image forming apparatus.

According to one aspect of the present disclosure, a conveying device for a recording material includes: a conveying portion configured to convey the recording material; a first side plate; a second side plate facing the first side plate; and a beam member mounted to the first side plate and the second side plate. The first side plate and the beam member are different from each other in plate thickness. One of the first side plate and the beam member includes a hole. A second one of the first side plate and the beam member includes an insertion portion inserted in the hole. The hole and the insertion portion form a positioning portion that positions the first side plate and the beam member in a first direction. The insertion portion includes a widened portion. The widened portion has a width in the first direction that increases from downstream to upstream in an inserting direction of the insertion portion into the hole. The widened portion includes a pair of end portions in the first direction that are in contact with an edge of the hole, in the first direction.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus to which an optional feeding device of Embodiment 1 is connected.

FIG. 2 is a perspective view of a frame of the image forming apparatus of Embodiment 1 viewed from the lower side.

FIG. 3 is a perspective view of a frame of the optional feeding device of Embodiment 1 viewed from the lower side.

FIG. 4 is a perspective view of the frame of the optional feeding device of Embodiment 1 viewed from the upper rear side.

FIG. 5 is an enlarged view of an area near a positioning portion of a right side plate and a rear top plate of Embodiment 1.

FIG. 6 is a side view of an area near the positioning portion of the right side plate and the rear top plate of Embodiment 1.

FIG. 7 is a front view of the positioning portion of the rear top plate of Embodiment 1.

FIG. 8 is a perspective view of a frame of an optional feeding device of Embodiment 2.

FIG. 9 is an enlarged view of an area near a positioning portion of a right side plate and a rear top plate of Embodiment 2.

FIG. 10 is an enlarged view of an area near the positioning portion of the right side plate of Embodiment 2.

FIG. 11 is a top view of the area near the positioning portion of the right side plate of Embodiment 2 viewed from the upper side.

FIG. 12 is an enlarged view of an area near a positioning portion of a left side plate and a rear top plate of Embodiment 2.

FIG. 13A is a perspective view of an area near the positioning portion of the left side plate of Embodiment 2.

FIG. 13B is an enlarged view of the area near the positioning portion of the left side plate of Embodiment 2.

FIG. 14 is a perspective view of a frame of an optional feeding device of Embodiment 3 viewed from the upper rear side.

FIG. 15 is a perspective view of an area near a positioning portion of a right side plate and a rear top plate of Embodiment 3.

FIG. 16 is a front view of a positioning portion of the rear top plate of Embodiment 3.

FIG. 17 is a side view (cross-sectional view) of the area near the positioning portion of the right side plate and the rear top plate of Embodiment 3.

FIG. 18 is an enlarged side view (cross-sectional view) of the area near the positioning portion of the right side plate and the rear top plate of Embodiment 3.

FIG. 19 is a perspective view of a frame of an image forming apparatus of Embodiment 4 viewed from the upper front side.

FIG. 20 is an exploded perspective view of the frame of the image forming apparatus of Embodiment 4 viewed from the upper front side.

FIG. 21A is a perspective view of an insertion portion of the top plate of Embodiment 4.

FIG. 21B is a perspective view of an insertion portion of the front plate of Embodiment 4.

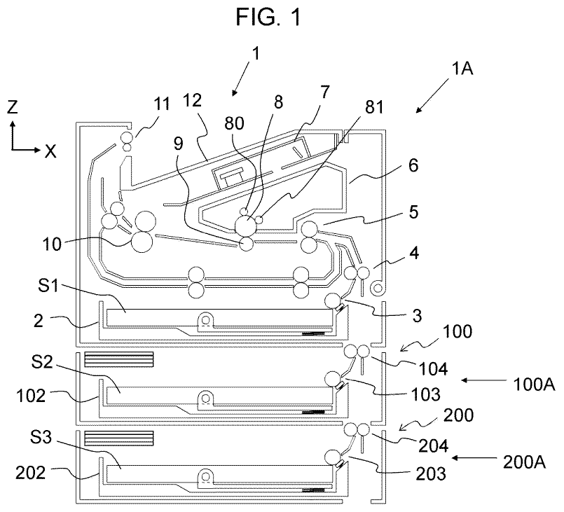

### DESCRIPTION OF THE EMBODIMENTS

[Embodiment 1] <General Configuration of Image Forming Apparatus> FIG. 1 is a cross-sectional view depicting a general configuration of an image forming system 1A in which an image forming apparatus 1 according to Embodiment 1 and feeding function extension devices (optional feeding devices) 100A and 200A, which function as conveying devices, are connected. In FIG. 1, a laser beam printer is illustrated as an example of the image forming apparatus 1. Dimensions, materials, forms of components, relative positions thereof and the like, to be described in the following embodiments, may be appropriately changed depending on the configuration of the apparatus to which the present disclosure is applied, and various conditions. That is, unless otherwise specified, these description are not intended to limit the scope of the present disclosure. In the following description, the Y direction is a rotating shaft direction of a conveying portion that conveys recording material, the Z direction is a perpendicular direction in a case where the image forming system 1A is installed on a horizontal plane, and the X direction is a direction orthogonally intersecting the Y direction and the Z direction. In the case where the image forming system 1A is installed on the horizontal plane, the X direction and the Y direction are parallel with the horizontal direction. The +X direction is a forward direction, the −X direction is a backward direction, the +Y direction is a direction to the right, and the −Y direction is direction to the left, the +Z direction is an upward direction, and the −Z direction is a downward direction.

The image forming apparatus 1 includes a drum type electrophotographic photosensitive member (hereafter called “photosensitive drum 8”) that functions as an image bearing member. The photosensitive drum 8 is constituted of a cylindrical drum body made of aluminum, nickel or the like, on which a photosensitive agent such as an organic photoconductor (OPC), amorphous selenium, or amorphous silicon, is disposed. The photosensitive drum 8 is rotatably supported by the main body of the image forming apparatus 1, and is rotated by a drive source (not shown) at a predetermined process speed. A charging member 80, a developing member 81, and a transfer roller 9 (transfer member) are disposed around the photosensitive drum 8, in sequence along the rotating direction of the photosensitive drum 8. A scanner unit 7 (exposing unit) is disposed above the photosensitive drum 8. The photosensitive drum 8, the charging member 80, and the developing member 81 are integrally configured as a process cartridge 6 detachable from the main body of the image forming apparatus 1.

The main body of the image forming apparatus 1 also includes, in sequence along a conveying path of a recording material S1, a cassette 2 in which the recording material S1 is loaded, a feeding portion 3, a conveying roller pair 4, a resist roller pair 5, fixing unit 10, a discharging roller pair 11, and a discharge tray 12. The recording material S1 is a sheet type recording medium, such as paper, cloth and film.

<Operation of Image Forming Apparatus> The following describes an operation of the image forming apparatus 1. The photosensitive drum 8 rotated by a drive source (not shown) is uniformly charged to a predetermined polarity and predetermined potential by the charging member 80. The scanner unit 7 exposes an image on the surface of the charged photosensitive drum 8 based on the image information, and an electrostatic latent image (latent image) is formed thereon when charges on the exposed portion are removed. The electrostatic latent image is developed by the developing member 81 so as to be visualized as a toner image.

The toner image on the photosensitive drum 8 is transferred to the recording material S1 by the transfer roller 9. The transfer roller 9 is biased toward the photosensitive drum 8 by a biasing member (not shown). By this configuration, a transfer nip portion is formed between the transfer roller 9 and the photosensitive drum 8. The transfer roller 9 performs the transfer operation using this transfer nip portion, whereby the toner image on the photosensitive drum 8 (on the image bearing member) is transferred to the recording material S1.

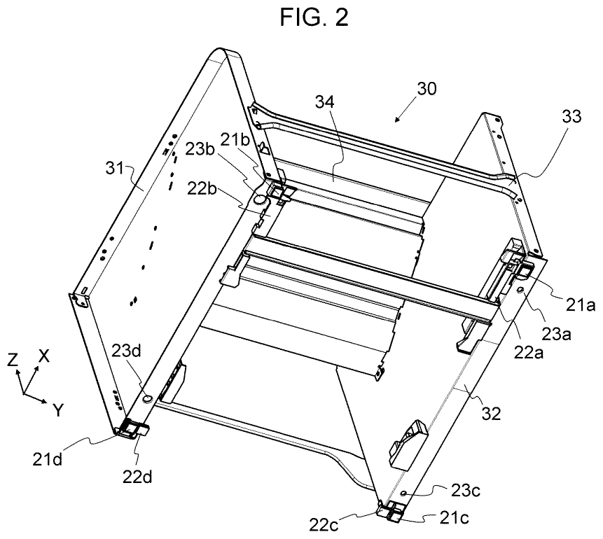

The recording material S1, on the other hand, is fed from the cassette 2, which loads and stores the recording material S1, to a conveying path by the feeding portion 3. The recording material S1 is conveyed to the transfer nip portion via the conveying roller pair 4 and the resist roller pair 5. The toner image having been transferred from the photosensitive drum 8 to the recording material S1 by the transfer nip portion is heated and fixed by the fixing unit 10. The recording material S1 having passed through the fixing unit 10 is discharged onto the discharge tray 12 via the discharging roller pair 11.

<Bottom Portion of Image Forming Apparatus> The following describes the configuration of a bottom portion of the image forming apparatus 1. FIG. 2 is a perspective view of a frame 30 constituting the main body of the image forming apparatus 1 viewed from the lower side. Ground contact portions 21a to 21d and device installation portions 22a to 22d are disposed on the bottom portion of the frame 30. The ground contact portions 21a to 21d are surfaces that contact with the installation surface when the image forming apparatus 1 is installed on the desktop or the like. The device installation portions 22a to 22d are surfaces that contact with a frame 100 when the image forming apparatus 1 is installed on the frame 100 of the optional feeding device 100A.

A member having a high friction coefficient (e.g. rubber) is attached respectively to the ground contact portions 21a to 21d in order to prevent sliding of the image forming apparatus 1 on the desktop or the like caused by user operation. Here it is assumed that the ground contact portions 21a to 21d are installed on the frame 100 of the optional feeding device 100A when the image forming apparatus 1 is installed on the frame 100 of the optional feeding device 100A. Then in some cases the compression amount of the rubber attached to each of the ground contact portions 21a to 21d may not become uniform due to weight imbalance. In this case, the image forming apparatus 1 may be installed at an angle to the frame 100 of the optional feeding device 100A. This may cause the image quality to drop due to skewed conveying of the recording material from the frame 100 of the optional feeding device 100A. In Embodiment 1, however, the device installation portions 22a to 22d are included in the image forming apparatus 1. Accordingly, when the image forming apparatus 1 is installed on the frame 100 of the optional feeding device 100A, the device installation portions 22a to 22d contact the frame 100 of the optional feeding device 100A instead of the ground contact portions 21a to 21d. This can prevent the image forming apparatus 1 from being installed at an angle with respect to the frame 100 of the optional feeding device 100A.

Positioning holes 23a to 23d are disposed on the bottom face of the frame 30. The positioning hole 23a disposed on the right side plate 32 is an oval hole disposed on the front right side of the image forming apparatus 1, and the positioning hole 23c is a round hole disposed on the rear right side of the image forming apparatus 1. The positioning hole 23b disposed on the left side plate 31 is an oval hole disposed on the front left side of the image forming apparatus 1, and the positioning hole 23d is an oval hole disposed on the rear left side of the image forming apparatus 1. These positioning holes 23a to 23d are used for positioning the image forming apparatus 1 and the frame 100 of the optional feeding device 100A.

<Configuration of Optional Feeding Device> The following describes the frame 100 of the optional feeding device 100A and the frame 200 of the optional feeding device 200A that are externally connected to the image forming apparatus 1. The optional feeding device 100A is a conveying device to convey a recording material, and is connected to the image forming apparatus 1, whereby an image forming system 1A, where the paper feeding function of the image forming apparatus 1 is extended, can be configured.

As illustrated in FIG. 1, the frame 100 of the optional feeding device 100A is connectable to the image forming apparatus 1 from the lower side. The optional feeding device 100A includes a cassette 102 that stores a sheet S2, a feeding unit 103 that feeds the sheet S2 stored in the cassette 102 to the conveying path, and a conveying roller pair 104 that is a conveying portion to convey the sheet S2. The rotating shaft direction of each roller constituting the conveying roller pair 104 is parallel with the Y direction. The sheet S2 stored in the cassette 102 is fed by the feeding unit 103, and is conveyed into the image forming apparatus 1 by the conveying roller pair 104, and an image is formed thereon via the above mentioned process.

The frame 200 of the optional feeding device 200A is connectable to the frame 100 of the optional feeding device 100A from the lower side. The optional feeding device 200A includes: a cassette 202 that stores a sheet S3; a feeding unit 203 that feeds the sheet S3 stored in the cassette 202 to the conveying path; and a conveying roller pair 204 that conveys the sheet S3. The sheet S3 stored in the cassette 202 is fed by the feeding unit 203, and is conveyed into the frame 100 of the optional feeding device 100A, and is then conveyed into the image forming apparatus 1 by the conveying roller pair 204, and an image is formed thereon via the above mentioned process.

As described above, the frames 100 and 200 of the optional feeding devices 100A and 200A can be connected to the image forming apparatus 1 as additional layers, whereby the amount and type of the sheets that can be stored in the image forming system 1A can be increased. FIG. 1 is an example where the optional feeding devices 100A and 200A are connected to the image forming apparatus 1 as two function extension devices, but a number of functional extension devices that are connectable is not limited to two, and one or three or more function extension devices may be connectable. These frames 100 and 200 of the optional feeding devices 100A and 200A have identical configurations, and the feeding units 103 and 203 and the cassettes 102 and 202 of the optional feeding devices 100A and 200A also have identical configurations of the feeding portion 3 and cassette 2 of the image forming apparatus 1 respectively.

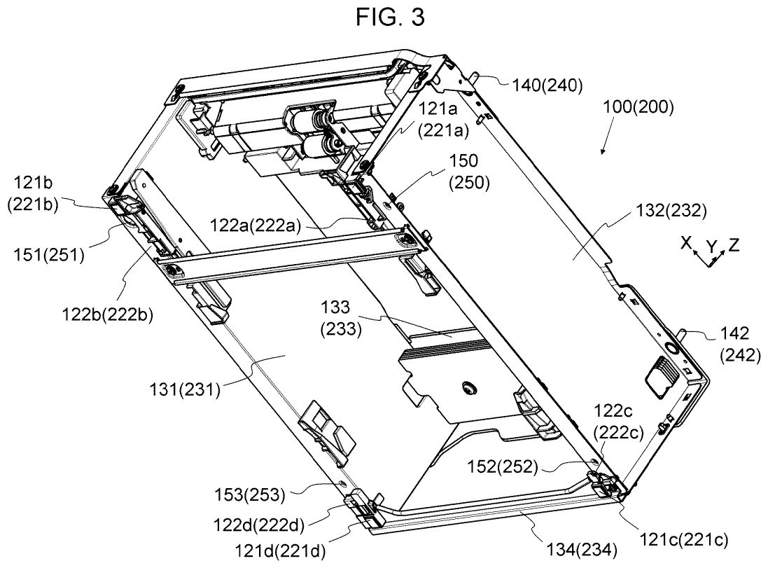

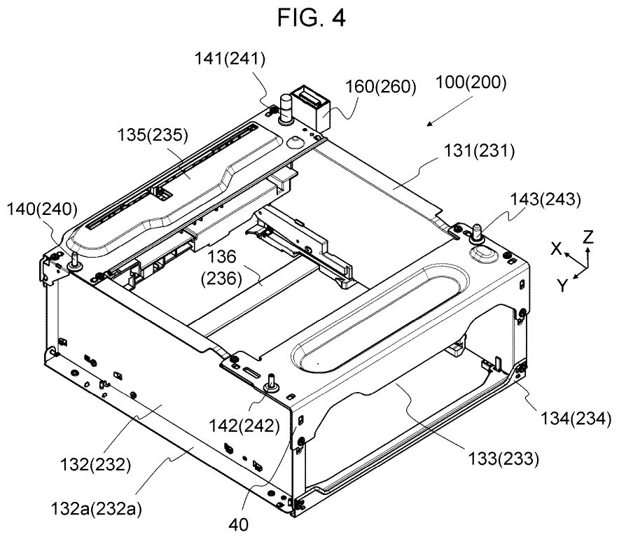

FIG. 3 is a perspective view of the frame 100 of the optional feeding device 100A viewed from the lower side. FIG. 4 is a perspective view of the frame 100 of the optional feeding device 100A viewed from the upper rear side.

As illustrated in FIG. 3, ground contact portions 121a to 121d and device installation portions 122a to 122d are disposed on the bottom portion of the frame 100 of the optional feeding device 100A, similarly to the image forming apparatus 1. The ground contact portions 121a to 121d are surfaces that contact with the installation surface when the frame 100 of the optional feeding device 100A is installed on the desktop or the like. The device installation portions 122a to 122d are surfaces that contact with the frame 200 of the optional feeding device 200A when the frame 100 of the optional feeding device 100A is installed on the frame 200 of the optional feeding device 200A.

A member having a high friction coefficient (e.g. rubber) is attached respectively to the ground contact portions 121a to 121d, in order to prevent sliding of the frame 100 of the optional feeding device 100A on the desktop or the like caused by user operation. Here it is assumed that the ground contact portions 121a to 121d are installed on the frame 200 of the optional feeding device 200A when the frame 100 of the optional feeding device 100A is installed on the frame 200 of the optional feeding device 200A. Then in some cases, the compression amount of the rubber attached to each of the ground contact portions 121a to 121d may not become uniform due to weight imbalance. In this case, the frame 100 of the optional feeding device 100A may be installed at an angle to the frame 200 of the optional feeding device 200A. This may cause the image quality to drop due to skewed conveying of the recording material from the frame 200 of the optional feeding device 200A. In Embodiment 1, however, the device installation portions 122a to 122d are included in the frame 100 of the optional feeding device 100A. Accordingly, when the frame 100 of the optional feeding device 100A is installed on the frame 200 of the optional feeding device 200A, the device installation portions 122a to 122d contact the frame 200 of the optional feeding device 200A. This can prevent the frame 100 of the optional feeding device 100A from being installed at an angle with respect to the frame 200 of the optional feeding device 200A.

Positioning holes 150 to 153 corresponding to positioning pins 140 to 143 are disposed on the bottom faces of a left side plate 131 and a right side plate 132 respectively. These positioning holes 150 to 153 are used to connect the frame 200 of the optional feeding device 200A below the frame 100 of the optional feeding device 100A.

As illustrated in FIG. 4, the positioning pins 140 to 143 are disposed at four locations on the top face of the frame 100 of the optional feeding device 100A. The positioning pins 140 and 141 are disposed on both end portions of the frame 100 in the longitudinal direction (Y direction, left-right direction) of the conveying roller pair 104. The positioning pins 142 and 143 are disposed on both end portions of a rear top plate 133 in the Y direction. The positioning pins 140 and 142 are disposed near both end portions of the right side plate 132 in the conveying direction (X direction, front-back direction) of the recording material. The positioning pins 141 and 143 are disposed near both end portions of the left side plate 131 in the X direction. The rear top plate 133 has no conveying path and is distant from the cassette 2. Accordingly, the shape of the rear top plate 133 is quite flexible. In Embodiment 1, the rear top plate 133 is the most rigid component among the components constituting the frame 100 of the optional feeding device 100A. The rigidity of the positioning pins 142 and 143 disposed on the rear top plate 133 is also high.

The image forming apparatus 1 and the frame 100 of the optional feeding device 100A are electrically connected by a drawer connector 160.

The frame 200 of the optional feeding device 200A includes ground contact portions 221a to 221d, device installation portions 222a to 222d, positioning pins 240 to 243, positioning holes 250 to 253, a rear top plate 233, a left side plate 231, a right side plate 232, and a drawer connector 260. The configuration of these components is the same as the frame 100 of the optional feeding device 100A, hence detailed description is omitted.

<Configuration of Frame of Optional Feeding Device> As illustrated in FIGS. 3 and 4, the frame 100 of the optional feeding device 100A includes the right side plate 132 (first side plate) and the left side plate 131 that faces the right side plate 132. The frame 100 is installed on the right side plate 132 and the left side plate 131, and includes the rear top plate 133, a rear bottom plate 134, a front top plate 135, and a front bottom plate 136 that are beam members connecting the right side plate 132 and the left side plate 131. The rear top plate 133 and the front top plate 135, in particular, are disposed on the outer side of the left side plate 131 and the right side plate 132, and the rear top plate 133 and the front top plate 135 constitute ridges of the frame 100. Thus, the rigidity of the rear top plate 133 and the front top plate 135 greatly influences the solidity of the frame 100.

A material of the components constituting the frame 100 of the optional feeding device 100A is a metal, and the components are fastened to each other by screws. The left side plate 131, the right side plate 132, the rear top plate 133, the rear bottom plate 134, the front top plate 135, and the front bottom plate 136 are metal plate members, and are formed by sheet metal.

In Embodiment 1, the thickness of a component is defined as follows. A surface that is parallel with a first surface of the component and is closest to the first surface is regarded as a second surface of the component. The second surface is located on the rear side of the first surface. In other words, the first surface and the second surface overlap when viewed in a direction vertical to the first surface. The thickness is a distance between the first surface and the second surface. When the thickness (plate thickness) of a plate type member is defined, the first surface is a surface having a widest area among the members. That is, in a case of sheet metal, the first surface and the second surface are surfaces vertical to the shear surface. In other words, when the thickness (plate thickness) of a plate type member is defined, the total area of the first surface becomes the largest wherein the distance from the first surface to the second surface is equal to the plate thickness.

The rear top plate 133 has the largest plate thickness among the components constituting the frame 100 of the optional feeding device 100A, and the plate thickness is at least triple (about four times in Embodiment 1) the plate thickness of the other components. This means that the plate thickness of the right side plate 132 (first side plate) and the plate thickness of the rear top plate 133 (beam member) are different from each other. The plate thickness of the right side plate 132 (one of the right side plate 132 and the rear top plate 133) is thinner than the plate thickness of the rear top plate 133 (the other of the right side plate 132 and the rear top plate 133). The plate thickness of the rear top plate 133 is at least triple (about four times in Embodiment 1) the plate thickness of the right side plate 132. In the same manner, the plate thickness of the left side plate 131 (second side plate) and the plate thickness of the rear top plate 133 are different from each other. The plate thickness of the left side plate 131 (one of the left side plate 131 and the rear top plate 133) is thinner than the plate thickness of the rear top plate 133 (the other of the left side plate 131 and the rear top plate 133). The plate thickness of the rear top plate 133 is at least triple (about four times in Embodiment 1) the plate thickness of the left side plate 131. The weight of the rear top plate 133 is heavier than the total weight of the left side plate 131 and the right side plate 132. The rigidity of the rear top plate 133 is highest among the components constituting the frame 100.

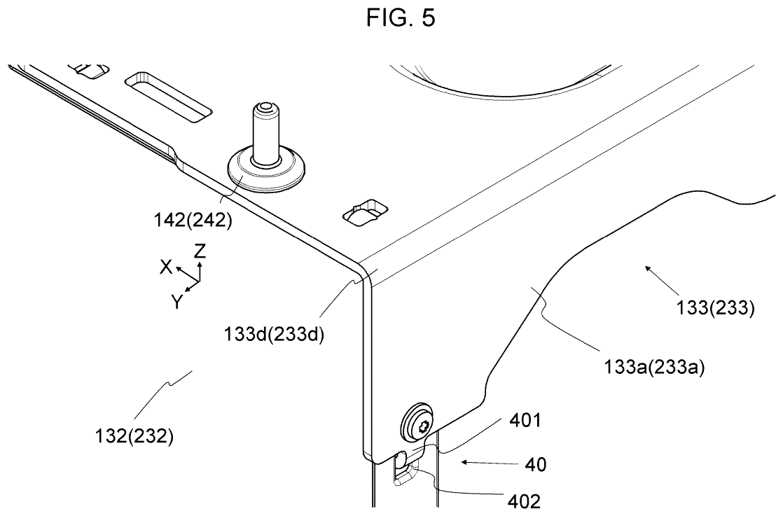

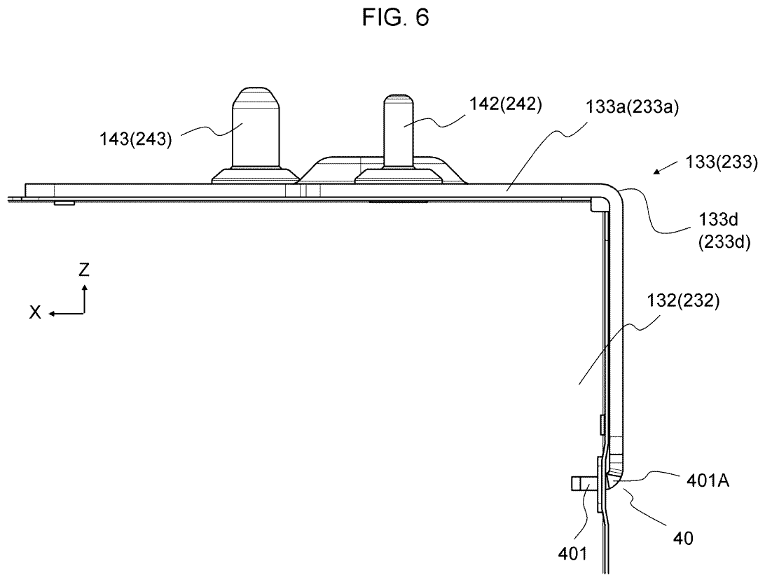

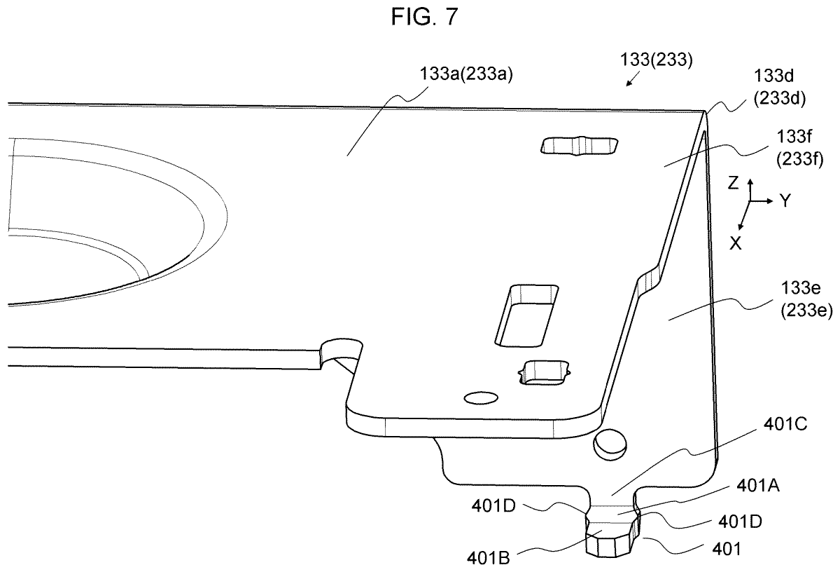

FIG. 5 is an enlarged view of an area near a positioning portion 40 of the right side plate 132 and the rear top plate 133 in FIG. 4. FIG. 6 is a side view of the area near the positioning portion 40 of the right side plate 132 and the rear top plate 133. FIG. 7 is a front view of the positioning portion 40 of the rear top plate 133.

The right side plate 132 (one of the right side plate 132 and the rear top plate 133) includes a hole 402. The rear top plate 133 (the other of the right side plate 132 and the rear top plate 133) includes an insertion portion 401 inserted in the hole 402. By inserting the insertion portion 401 into the hole 402, the right side plate 132 and the rear top plate 133 are positioned with respect to each together in the first direction (Y direction in Embodiment 1).

The rear top plate 133 includes a frame component 133a, and the right side plate 132 includes a frame component 132a. The frame component 133a includes a top plate portion 133f extending in the XY direction crossing with the Z direction, and a rear plate portion 133e that is a flat portion extending in the YZ direction crossing with the inserting direction (X direction). The top plate portion 133f and the rear plate portion 133e are connected via ridge portion 133d extending in the Y direction. The insertion portion 401 is disposed at an end portion that is distant from the ridge portion 133d of the frame component 133a in the −Z direction.

As illustrated in FIG. 7, the rear top plate 133 includes a bent portion 401A. The insertion portion 401 also includes the bent portion 401A. In other words, at least a part of the bent portion 401A is inserted in the hole 402. Further, a protruding portion (first protruding portion) 401D is disposed on one end (first end) of the bent portion 401A in a generatrix direction of the bent portion 401A, and a protruding portion (second protruding portion) 401D is disposed on the other end (second end opposite the first end) of the bent portion 401A. The generatrix direction of the bent portion 401A is parallel with the first direction. The insertion portion 401 includes the bent portion 401A and these protruding portions 401D. In a state where the insertion portion 401 is inserted in the hole 402 in the inserting direction (+X direction in Embodiment 1), these protruding portions 401D are in contact with the edge of the hole 402.

In Embodiment 1, the rear top plate 133 is formed by a bent sheet metal. When the sheet metal is bent, protruding portions (bent bumps) protrude in the generatrix direction of the bent portion. The protruding portions 401D in Embodiment are bent bumps.

Specifically, the rear top plate 133 includes a root portion 401C and a tip portion 401B that extends in a direction crossing the root portion 401C. The bent portion 401A is disposed between the root portion 401C and the tip portion 401B. This means that the root portion 401C is a part of the rear plate portion 133e being a flat portion. In Embodiment 1, the root portion 401C is located at an end portion of the rear plate portion 133e in the −Z direction, and the tip portion 401B extends toward downstream (toward the +X direction) in the inserting direction. The insertion portion 401 includes the tip portion 401B. A portion of the insertion portion 401 is a widened portion having a width in the first direction (Y direction) that increases from the downstream to the upstream side in the inserting direction into the hole 402. In Embodiment 1, the width of the insertion portion 401 is increased by the protruding portion 401D. In other words, the widened portion includes the protruding portion 401D.

In a state before the insertion portion 401 is inserted in the hole 402 (a state where an external force is not applied), the width of the bent portion 401A of the insertion portion 401 in the positioning direction (Y direction) is larger than the width of the tip portion 401B of the insertion portion 401 in the Y direction and the width of the hole 402 in the Y direction. When the insertion portion 401 is inserted into the hole 402, the protruding portions 401D, which are widened portions at both end portions of the bent portion 401A in the first direction (Y direction), contact with the edge of the hole 402 in the first direction (Y direction). The positioning portion 40, for positioning the right side plate 132 and the rear top plate 133 in the first direction (Y direction), is implemented by the hole 402 and the insertion portion 401. In other words, the positioning portion 40 positions the rear top plate 133 and the right side plate 132 in the Y direction.

In the case of installing the rear top plate 133 to the right side plate 132, the insertion portion 401 (a part of the rear top plate 133), which has a large plate thickness and high rigidity, is inserted in the hole 402 of the right side plate 132 lower in rigidity than the rear top plate 133. Here the bent portion 401A elastically deforms the right side plate 132 in the inserting direction (+X direction). Thereby in the positioning portion 40, an area near the hole 402 of the right side plate 132 is pushed by the bent portion 401A, as illustrated in FIG. 6, and is elastically deformed in the inserting direction (+X direction) of the insertion portion 401 into the hole 402, and is retracted in the +X direction.

Both end portions of the protruding portion 401D in the positioning direction (Y direction) of the bent portion 401A inserted in the hole 402 are in contact with the edge of the hole 402. In other words, the two surfaces facing each other in the positioning direction (Y direction), among the inner peripheral surfaces of the hole 402, are in contact with both end portions of the protruding portion 401D in the Y direction. By this configuration, the right side plate 132 and the rear top plate 133, having high rigidity, are positioned in the Y direction without any gap, hence the solidity of the frame 100 becomes high.

In the positioning portion 40, the right side plate 132 and the rear top plate 133 are positioned without any gap in the width direction (Y direction) of the product. Accordingly, the solidity of the frame 100 increases in the direction (Y direction) orthogonal to the paper conveying direction. This prevents a drop in printing accuracy caused by deformation of the frame 100.

Further, in the rear top plate 133, the positioning portion 40 is located near the end of the −Z direction, which is distant from the ridge portion 133d at the upper rear portion of the frame 100. This generates an effect of enhancing torsional rigidity of the frame 100.

The inserting direction (+X direction) is a direction toward the inner side of the optional feeding device 100A (conveying device). Accordingly, the portion of the right side plate 132, which is elastically deformed and retracted (portion near the hole 402), is on the inner side of the optional feeding device 100A, compared with the rear top plate 133 (on the +X direction side of the rear plate portion 133e). This means that the outer form of the frame 100 is not changed by this elastic deformation. Hence the exterior component externally attached to the frame 100 and the appearance of the product determined by the exterior component are not influenced by the elastic deformation.

Furthermore, the rear top plate 133, which is a member having a large plate thickness and high rigidity, is heavier than the right side plate 132 having a thin plate thickness. In Embodiment 1, in the positioning portion 40, there is no gap between the insertion portion 401 of the rear top plate 133 and the hole 402 of the right side plate 132. Accordingly, when the optional feeding device 100A receives impact, it can be prevented that the heavy rear top plate 133 is moved by inertia and the frame 100 is deformed thereby. In particular, deformation of the frame 100 in the width direction of the recording material can be suppressed. This prevents a drop in printing accuracy.

<Positioning Method> The following describes the positioning of the image forming apparatus 1 and the frame 100 of the optional feeding device 100A. In a case where the image forming apparatus 1 is disposed on the frame 100 of the optional feeding device 100A, the positioning pins 140 to 143 of the frame 100 of the optional feeding device 100A are interfitted with the positioning holes 23a to 23d formed on the image forming apparatus 1. The positioning pins 142 and 143 are disposed in the Y direction on both sides of the rear top plate 133 having high rigidity. The rear top plate 133 is positioned in the Y direction with respect to the right side plate 132 via the positioning portion 40. This means that the rigidity of the bearing surfaces of the positioning pins 142 and 143 is high, and the change of the positional relationship between the positioning pins 142 and 143 and the right side plate 132 is suppressed thereby. Hence deformation of the frame 100 caused by impact or the like on the apparatus and a drop in the image quality can be prevented.

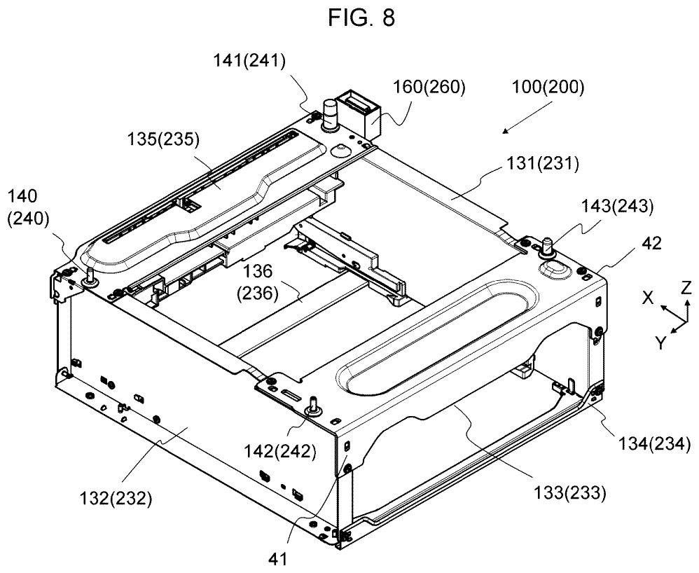

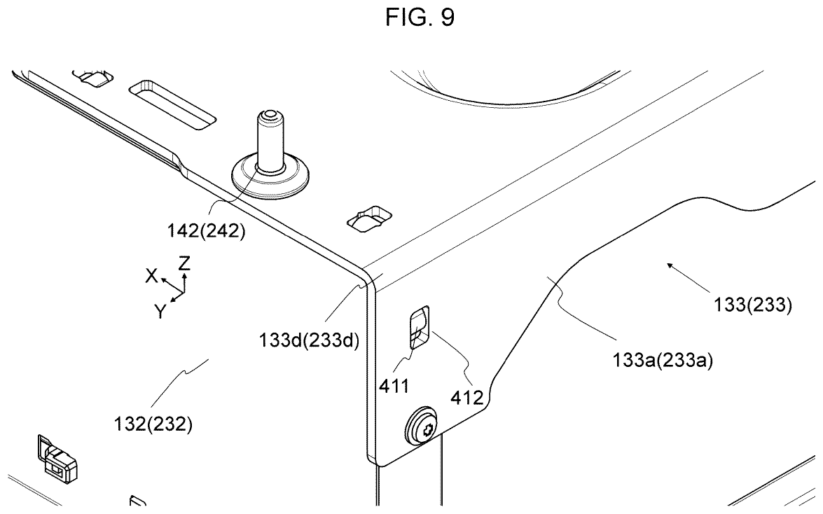

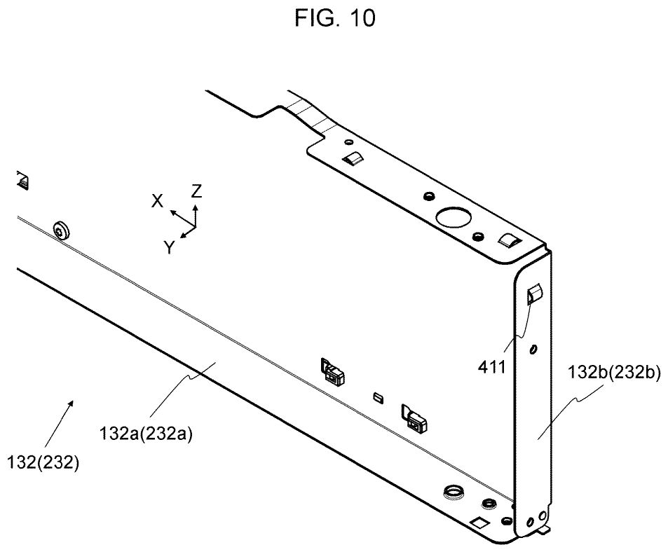

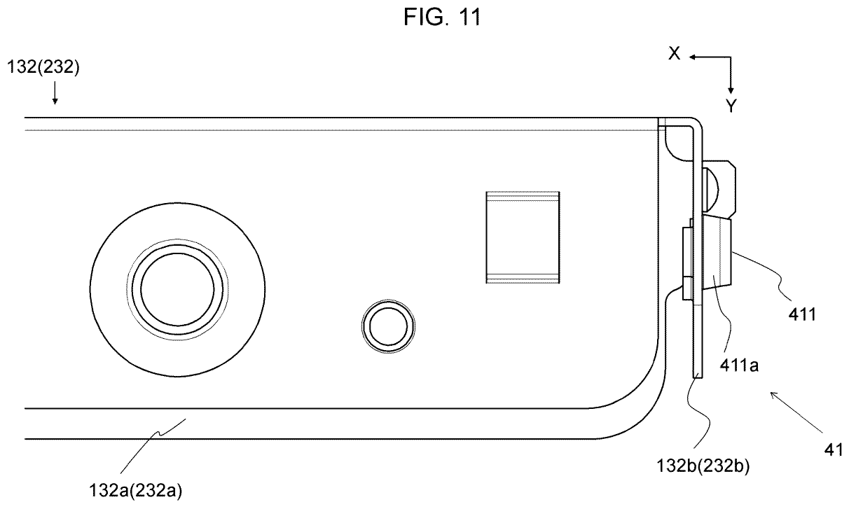

The frame 200 of the optional feeding device 200A includes the left side plate 231, the right side plate 232, the frame component 232a, a rear top plate 233, a ridge portion 233d, a rear plate portion 233e, a top plate portion 233f, a rear bottom plate 234, a front top plate 235, a front bottom plate 236, and a frame component 233a. The configuration of these components are the same as that of the frame 100 of the optional feeding device 100A, hence detailed description thereof is omitted. The positioning of the frame 100 of the optional feeding device 100A and the frame 200 of the optional feeding device 200A is also the same, hence detailed description of the positioning pins 240 to 243 is also omitted.

[Embodiment 2] The following describes Embodiment 2 with reference to FIGS. 8 to 13B. A composing element the same as Embodiment 1 is denoted with the same reference sign, and description thereof is omitted. FIG. 8 is a perspective view of the frame 100 of the optional feeding device 100A according to Embodiment 2 viewed from the upper rear side. FIG. 9 is an enlarged view of an area near a positioning portion 41 of the right side plate 132 and the rear top plate 133 in FIG. 8. FIG. 10 is a view of the right side plate 132 at the same viewpoint and same position as FIG. 9. FIG. 11 is a top view of the area near the positioning portion 41 of the right side plate 132 viewed from the upper side.

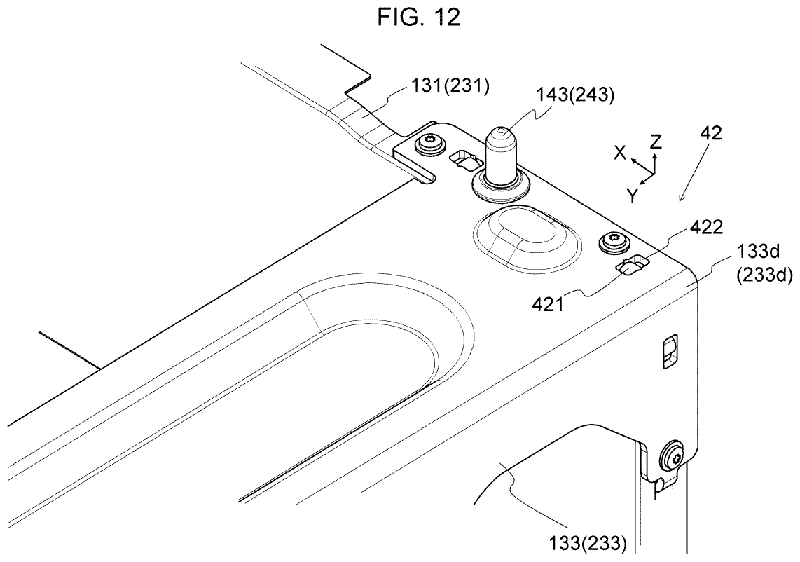

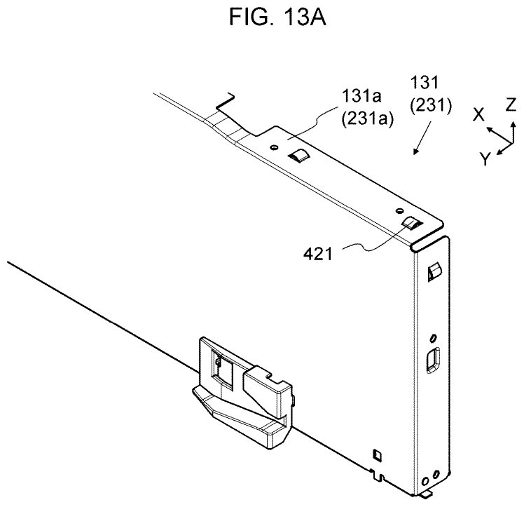

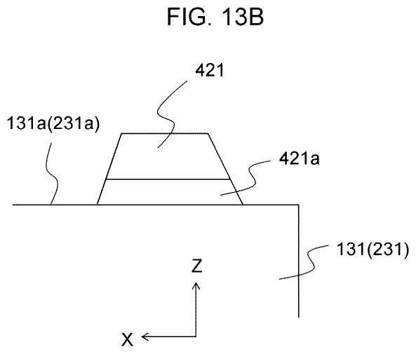

FIG. 12 is an enlarged view of an area near a positioning portion 42 of the left side plate 131 and the rear top plate 133 in FIG. 8. FIG. 13A is a view of the left side plate 131 at the same viewpoint and same position as FIG. 12. FIG. 13B is a side view of the area near the positioning portion 42 of the left side plate 131 viewed from the side (in the −Y direction).

As illustrated in FIG. 8, the frame 100 of the optional feeding device 100A includes the right side plate 132 (first side plate) and the left side plate 131 that faces the right side plate 132. The frame 100 further includes the rear top plate 133, the rear bottom plate 134, the front top plate 135, and the front bottom plate 136 that are beam members mounted to the right side plate 132 and the left side plate 131 and connect the right side plate 132 and the left side plate 131. The rear top plate 133 and the front top plate 135 are disposed outside the left side plate 131 and the right side plate 132, and the rear top plate 133 and the front top plate 135 constitute the ridge portion of the frame 100, and accordingly greatly influences the solidity of the frame 100.

A material of the components constituting the frame 100 of the optional feeding device 100A is a metal, and the components are fastened to each other by screws. The left side plate 131, the right side plate 132, the rear top plate 133, the rear bottom plate 134, the front top plate 135, and the front bottom plate 136 are metal plate members, and are formed by sheet metal. The rear top plate 133 has the largest plate thickness among the components constituting the frame 100 of the optional feeding device 100A, and accordingly has high rigidity. This means that the plate thickness of the right side plate 132 (first side plate) and the plate thickness of the rear top plate 133 (beam member) are different from each other. The plate thickness of the rear top plate 133 (one of the right side plate 132 and the rear top plate 133) is thicker than the plate thickness of the right side plate 132 (the other of the right side plate 132 and the rear top plate 133). Further, the plate thickness of the rear top plate 133 (one of the left side plate 131 and the rear top plate 133) is thicker than the plate thickness of the left side plate 131 (the other of the left side plate 131 and the rear top plate 133).

The rear top plate 133 includes the frame component 133a, the right side plate 132 includes the frame component 132a, and the left side plate 131 includes the frame component 131a.

The rear top plate 133, which is one of the right side plate 132 (the first side plate) and the rear top plate 133 (the beam member), includes a hole 412. The right side plate 132, which is the other of the right side plate 132 (the first side plate) and the rear top plate 133 (the beam member), includes an insertion portion 411 inserted in the hole 412. The insertion portion 411 has a protruded cone shape, where the size in the product width direction (Y direction) increases from the tip to the root (+X direction). The hole 412 is disposed at a position distant from the ridge portion 133d of the frame component 133a in the −Z direction.

The rear top plate 133, which is one of the left side plate 131 (the second side plate) and the rear top plate 133 (the beam member), includes a hole 422. The left side plate 131, which is the other of the left side plate 131 (the second side plate) and the rear top plate 133 (the beam member), includes an insertion portion 421 inserted in the hole 422. The insertion portion 421 has a protruded cone shape, similarly to the insertion portion 411, where the size in the product front-back direction (X direction) increases from the tip to the root (−Z direction). The hole 422 is disposed at a position distant from the ridge portion 133d of the frame component 133a in the +X direction.

The hole 412 of the rear top plate 133 and the insertion portion 411 of the right side plate 132 constitute the positioning portion 41 in the product width direction (Y direction). The right side plate 132, which is the other of the right side plate 132 and the rear top plate 133, includes a flat portion 132b that is made of metal and has a plane shape crossing (orthogonally in Embodiment 2) with the −X direction (inserting direction). The insertion portion 411 is a protruding portion that protrudes from the flat portion 132b toward downstream in the inserting direction (in the −X direction). A root portion 411a being a widened portion is formed at the root portion of the protruding portion.

In the case of installing the rear top plate 133 to the right side plate 132, the insertion portion 411 of the right side plate 132 lower in rigidity than the rear top plate 133 is inserted in the hole 412 of the rear top plate 133 that has a large plate thickness and high rigidity. Here the insertion portion 411 elastically deformed and is retracted. In other words, in the state before the insertion portion 411 is inserted in the hole 412 (state where an external force is not applied), the insertion portion 411 is a widened portion where the width in the Y direction increases from downstream to upstream in the inserting direction (−X direction). The width in the Y direction of the root portion 411a of the insertion portion 411 on the +X direction side is wider than the width in the Y direction of the hole 412. Since the insertion portion 411 having a low rigidity is inserted in the hole 412 having high rigidity, the root portion 411a of the insertion portion 411 is elastically compressed in the Y direction. Both end portions of the root portion 411a of the insertion portion 411 in the Y direction contact with the edge of the hole 412 in the Y direction: in detail, contact with two surfaces facing each other in the Y direction among the inner peripheral surfaces of the hole 412. By this configuration, the right side plate 132 and the rear top plate 133 are positioned in the Y direction without any gap. In other words, the insertion portion 411 and the hole 412 constitute the positioning portion 41 for positioning the rear top plate 133 and the right side plate 132 in the first direction (Y direction).

The hole 422 of the rear top plate 133 and the insertion portion 421 of the left side plate 131 constitute the positioning portion 42 in the product front-back direction (X direction). The left side plate 131 being the other of the left side plate 131 and the rear top plate 133 includes the frame component 131a that is a flat portion made of metal and has a plane shape crossing (orthogonally in Embodiment 2) with the +Z direction (inserting direction). The insertion portion 421 is a protruding portion that protrudes from the frame component 131a toward downstream in the inserting direction (in the +Z direction). A root portion 421a being a widened portion is formed at the root portion of the protruding portion.

In the case of installing the rear top plate 133 to the left side plate 131, the insertion portion 421 of the left side plate 131 lower in rigidity than the rear top plate 133 is inserted in the hole 422 of the rear top plate 133 that has a large plate thickness and high rigidity, similarly to the positioning portion 41. Here the insertion portion 421 elastically deforms and is retracted. In other words, in the state before the insertion portion 421 is inserted in the hole 422 (state where external force is not applied), the insertion portion 421 is a widened portion where the width in the X direction increases from downstream to upstream in the inserting direction (+Z direction). The width in the X direction of the root portion 421a of the insertion portion 421 on the −Z direction side is wider than the width in the X direction of the hole 422. Since the insertion portion 421 having a low rigidity is inserted in the hole 422 having a high rigidity, the root portion 421a of the insertion portion 421 is elastically compressed in the X direction. Both end portions of the root portion 421a of the insertion portion 421 in the X direction contact with the edge of the hole 422 in the X direction: in detail, contact with two surfaces facing each other in the X direction among the inner peripheral surfaces of the hole 422. By this configuration, the left side plate 131 and the rear top plate 133 are positioned in the X direction without any gap. In other words, the insertion portion 421 and the hole 422 constitute the positioning portion 42 for positioning the rear top plate 133 and the left side plate 131 in the second direction (X direction).

This means that the rear top plate 133 is positioned with both the left side plate 131 and the right side plate 132 without any gap, and the positioning directions thereof are different. Accordingly, the frame 100 of the optional feeding device 100A has high solidity in the torsional direction.

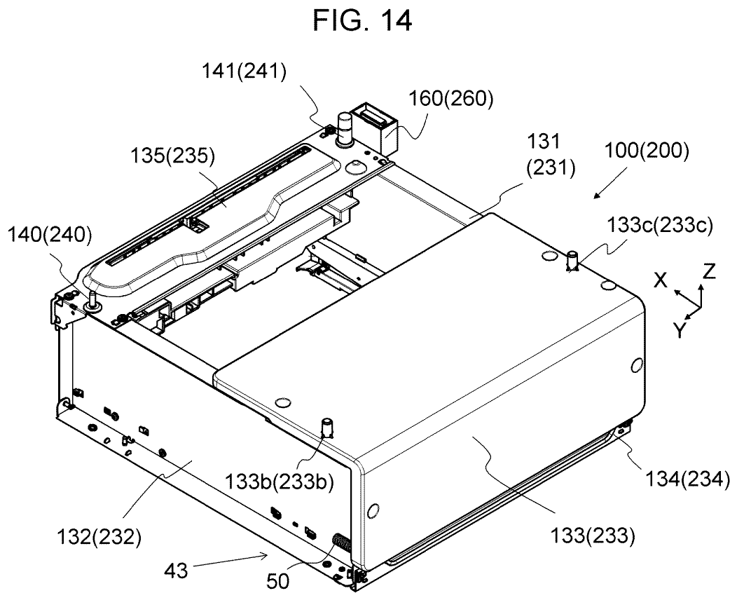

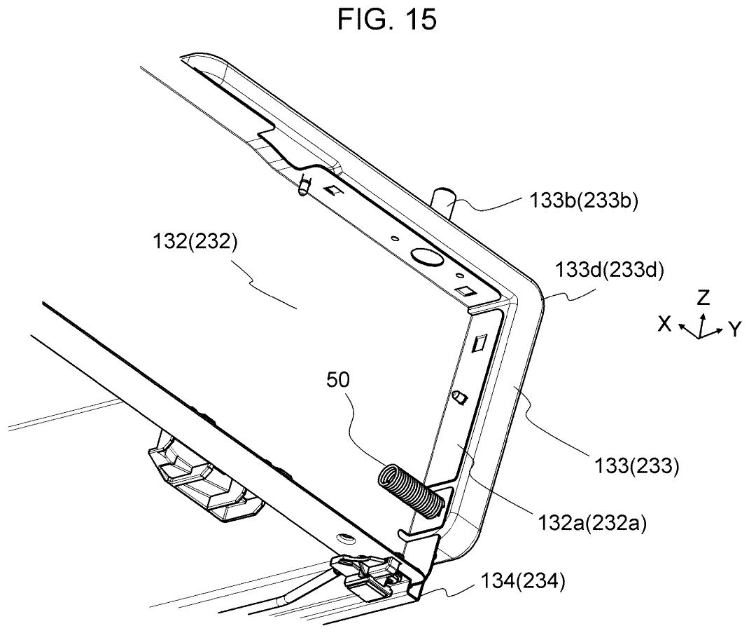

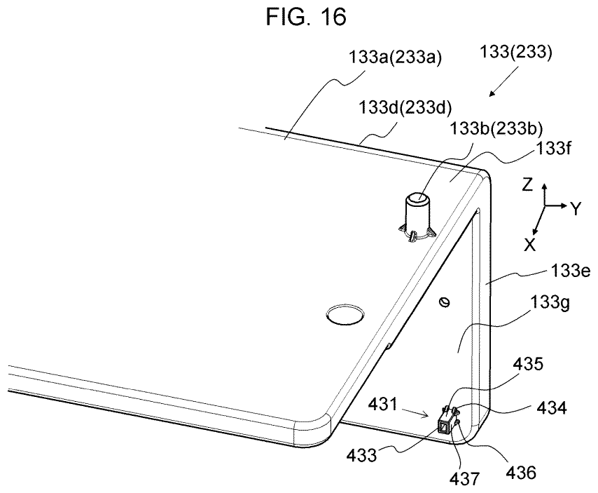

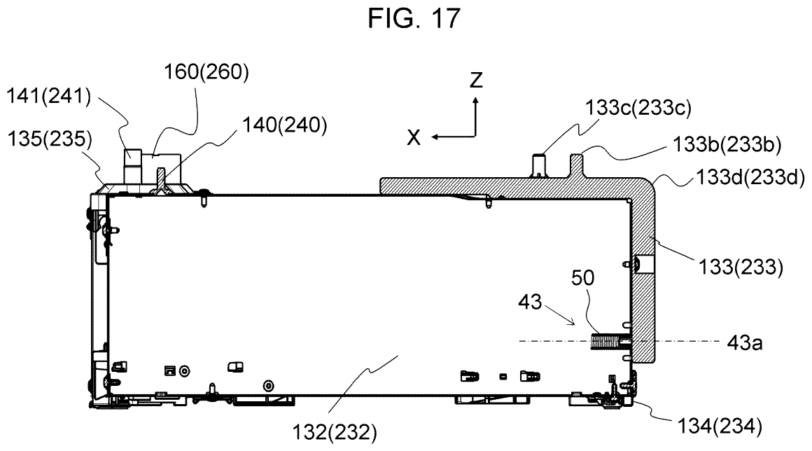

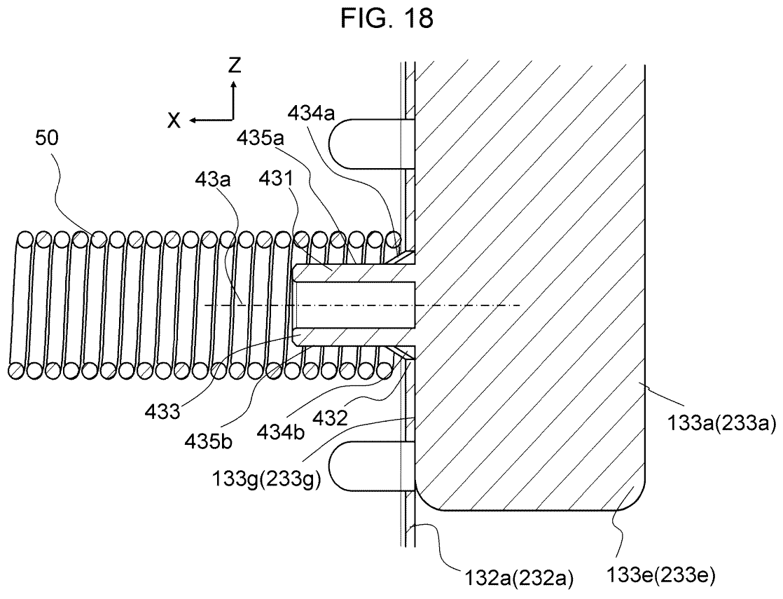

The configurations of the frame component 231a of the left side plate 231 and the frame component 232a and 232b of the right side plate 232 in the frame 200 of the optional feeding device 200A are the same as those in the frame 100 of the optional feeding device 100A, hence detailed description thereof is omitted.

[Embodiment 3] The following describes Embodiment 3 with reference to FIGS. 14 to 18. A composing element the same as Embodiment 1 or Embodiment 2 is denoted with a same reference sign, and description thereof is omitted. FIG. 14 is a perspective view of the frame 100 of the optional feeding device 100A according to Embodiment 3 viewed from the upper rear side. FIG. 15 is an enlarged view of the area near the positioning portion 43 of the right side plate 132 and the rear top plate 133. FIG. 16 is a front view of the positioning portion 43 of the rear top plate 133. FIG. 17 is a cross-sectional view of the positioning portion 43 of Embodiment 3, sectioned at a plane including a central shaft line 43a. FIG. 18 is an enlarged view of the area near the positioning portion 43 in FIG. 17.

As illustrated in FIG. 14, the frame 100 of the optional feeding device 100A includes the right side plate 132 (first side plate) and the left side plate 131 that faces the right side plate 132. The frame 100 is installed to the right side plate 132 and the left side plate 131, and includes the rear top plate 133, the rear bottom plate 134, the front top plate 135, and the front bottom plate (not shown) that are beam members connecting the right side plate 132 and the left side plate 131. The rear top plate 133 and the front top plate 135 are disposed outside the left side plate 131 and the right side plate 132, and the rear top plate 133 and the front top plate 135 constitute the ridge portion of the frame 100, and accordingly greatly influence the solidity of the frame 100.

A material of the components constituting the frame 100 of the optional feeding device 100A is a metal, except for the rear top plate 133, and are formed by sheet metal. The rear top plate 133 is formed of plastic. The plate thickness of the rear top plate 133 is sufficiently larger than the plate thicknesses of the other composing elements of the frame 100. This means that the plate thickness of the right side plate 132 (first side plate) and the plate thickness of the rear top plate 133 (beam member) are different from each other. The plate thickness of the right side plate 132 (one of the right side plate 132 and the rear top plate 133) is thinner than the plate thickness of the rear top plate 133 (the other of the right side plate 132 and the rear top plate 133). Further, the material of the rear top plate 133 is plastic, which makes the form of the rear top plate 133 more flexible. Accordingly, while enhancing the solidity of the frame 100, the flexibility of the product configuration increases.

The rear top plate 133 includes the frame component 133a, and the right side plate 132 includes the frame component 132a.

The right side plate 132 (one of the right side plate 132 (first side plate) and the rear top plate 133 (beam member)) includes a hole 432. The rear top plate 133 (the other of the right side plate 132 (first side plate) and the rear top plate 133 (beam member)) includes an insertion portion 431 inserted in the hole 432. Positioning in the product width direction (Y direction) and the perpendicular direction (Z direction) is performed by inserting the insertion portion 431 of the rear top plate 133 into the hole 432 of the right side plate 132.

The rear top plate 133 also includes positioning portions 133b and 133c. The positioning portions 133b and 133c are used to perform positioning of the optional feeding device 100A and the image forming apparatus 1 installed thereon. The frame component 133a includes the top plate portion 133f extending in a flat plate shape in the XY direction and the rear plate portion 133e extending in a flat plate shape in the YZ direction. The insertion portion 431 is disposed near the end portion that is distant from the ridge portion 133d of the frame component 133a in the −Z direction.

The insertion portion 431 includes a prism portion 433 and ribs 434 and 436. The prism portion 433 protrudes from a surface 133g on the +X direction side of the rear plate portion 133e in the +X direction. The prism portion 433 includes a pair of side faces 435 facing each other in the Z direction and a pair of side faces 437 facing each other in the Y direction. The rib 434 is disposed so as to connect the side face 435 and the surface 133g, and the rib 436 is disposed so as to connect the side face 437 and the surface 133g. In the example illustrated in FIGS. 16 and 18, two ribs 434 are disposed on each side face 435, and two ribs 436 are disposed on each side face 437, but a number of ribs is not limited to this example. The ribs 434 are disposed at corresponding positions of the pair of side faces 435 respectively, and the ribs 436 are disposed at corresponding positions of the pair of side faces 437 respectively. More specifically, in the example in FIG. 18, the position in the Y direction of the rib 434a disposed on a first one face, a side face 435a, of the pair of side faces 435 is the same as the position in the Y direction of the rib 434b disposed on a second one face, a side face 435b, of the pair of side faces 435.

The two ribs 434a and 434b disposed at corresponding positions of the pair of side faces 435a and 435b are called “a pair of facing ribs 434” here. And the facing direction of the pair of side faces 435 on which the pair of facing ribs 434 are disposed respectively is called “a facing direction of the pair of facing ribs 434”. In the example in FIG. 18, the facing direction of the pair of facing ribs 434 is the Z direction.

The distance between the end portions of the pair of facing ribs 434 in the facing direction (distance in the Z direction) increases in the direction toward the root of the prism portion 433 (in the −X direction). In the same manner, the distance between the end portions of the pair of facing ribs 436 in the facing direction (direction in the Y direction) increases in the direction toward the root of the prism portion 433 (in the −X direction). In other words, the pair of ribs 434 facing the insertion portion 431 is the widened portion having a width in the second direction (Z direction) that increases from downstream to upstream in the inserting direction (+X direction) of the insertion portion 431 into the hole 432. Further, the pair of ribs 436 facing the insertion portion 431 is the widened portion having a width in the first direction (Y direction) that increases from downstream to upstream in the inserting direction (+X direction) of the insertion portion 431 into the hole 432.

The following describes the distance between the end portions of the pair of facing ribs 434 in the facing direction (Z direction) at the root of the prism portion 433. This distance is larger than the size of the hole 432 in the facing direction (Z direction) in the state before the insertion portion 431 of the rear top plate 133 is inserted in the hole 432 of the right side plate 132 (state where an external force is not applied). Accordingly, when the insertion portion 431 being a part of the rear top plate 133 having high rigidity is inserted in the hole 432 of the right side plate 132 lower in rigidity than the insertion portion 431, the hole 432 is elastically deformed to stretch in the facing direction. Thereby both end portions of the insertion portion 431 in the facing direction of the pair of facing ribs 434 contact with the edge of the hole 432: in detail, contact with two surfaces facing each other in the facing direction among the inner peripheral surfaces of the hole 432. By this configuration, the rear top plate 133 and the right side plate 132 are positioned in the facing direction (Z direction) without any gap.

The distance between the end portions of the pair of facing ribs 436 in the facing direction (Y direction) at the root of the prism portion 433 is also the same as above. In other words, this distance is larger than the size of the hole 432 in the facing direction (Y direction) in the state before the insertion portion 431 of the rear top plate 133 is inserted in the hole 432 of the right side plate 132 (state where an external force is not applied). Accordingly, when the insertion portion 431 being a part of the rear top plate 133 having high rigidity is inserted in the hole 432 of the right side plate 132 lower in rigidity than the insertion portion 431, the hole 432 is elastically deformed to stretch in the facing direction. Thereby both end portions of the insertion portion 431 in the facing direction of the pair of facing ribs 436 contact with the edge of the hole 432: in detail, contact with two surfaces facing each other in the facing direction among the inner peripheral surfaces of the hole 432. By this configuration, the rear top plate 133 and the right side plate 132 are positioned in the facing direction (Y direction) without any gap.

This means that the hole 432 and the insertion portion 431 is the positioning portion 43 that positions the right side plate 132 and the rear top plate 133 in the Y direction (first direction) and the Z direction (second direction).

The positioning portions 133b and 133c interfit with the holes formed on the bottom portion of the image forming apparatus 1 when the image forming apparatus 1 is disposed on the frame 100 of the optional feeding device 100A. By disposing the pin-shaped positioning portions 133b and 133c on the rear top plate 133 having high rigidity, positional deviation between the image forming apparatus 1 and the optional feeding device 100A caused by impact on the apparatus or the like, and a drop in image quality caused thereby, can be prevented.

The biasing unit 50 includes a first side being in contact with a fixed portion (not shown) and a second side being in contact with a vicinity of the hole 432 of the right side plate 132, and biases the right side plate 132 toward the rear top plate 133. The biasing unit 50 biases the right side plate 132 (one of the right side plate 132 (first side plate) and the rear top plate 133 (beam member)) toward the rear top plate 133 (the other of the right side plate 132 and the rear top plate 133) in a direction parallel with the inserting direction (+X direction). By this configuration, the right side plate 132 and the rear top plate 133 are positioned without any gap, and the solidity of the frame 100 can be enhanced thereby.

In the configuration in Embodiment 3, the rear top plate 133 is made of plastic, and the right side plate 132 is made of metal, but the present invention is not limited thereto. For example, the rear top plate 133 may be made of metal, and the right side plate 132 may be made of plastic.

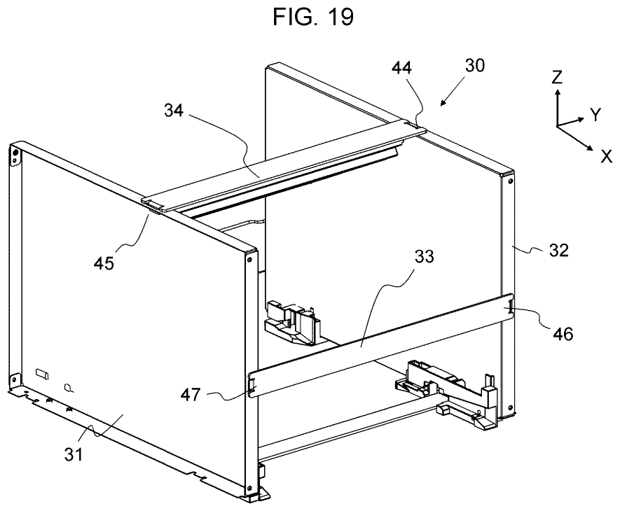

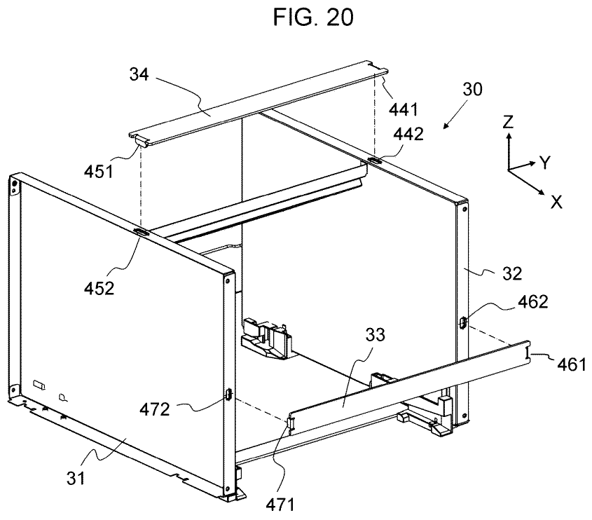

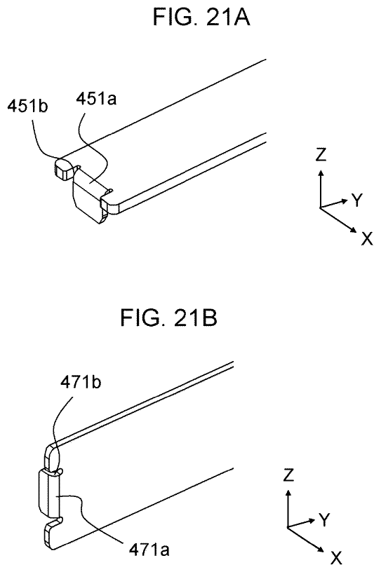

Configurations of the positioning portions 233b and 233c, the rear plate portion 233e, the top plate portion 233f, the surface 233g, and the like in the frame 200 of the optional feeding device 200A, are the same as those in the frame 100 of the optional feeding device 100A, hence detailed description thereof is omitted.

[Embodiment 4] The following describes Embodiment 4 with reference to FIGS. 19, 20, 21A, and 21B. A composing element the same as Embodiments 1 to 3 is denoted with a same reference sign, and description thereof is omitted. FIG. 19 is a perspective view of the frame 30 of the image forming apparatus 1 in Embodiment 4 viewed from the front. FIG. 20 is an exploded perspective view of the frame 30 in FIG. 19. FIG. 21A is an enlarged view of the insertion portion 451 of the top plate 34 viewed from the same viewpoint as FIG. 20. FIG. 21B is an enlarged view of the insertion portion 471 of the front plate 33 viewed from the same viewpoint as FIG. 20.

As illustrated in FIG. 19, the frame 30 of the image forming apparatus 1 includes the left side plate 31 and the right side plate 32 facing each other, and the front plate 33 and the top plate 34 that are beam members connecting the left side plate 31 and the right side plate 32, and these components are made of metal. The left side plate 31, the right side plate 32, the front plate 33 and the top plate 34 are sheet metal. The rigidity of the front plate 33 and the top plate 34 is higher than the other components constituting the frame 30 of the image forming apparatus 1. In particular, the rigidity of the front plate 33 and the top plate 34 is higher than that of the left side plate 31 and the right side plate 32. The top plate 34 and the left side plate 31 are positioned by the positioning portion 45, and the top plate 34 and the right side plate 32 are positioned by the positioning portion 44.

As illustrated in FIG. 20, the positioning portions 44 and 45 are configured such that the insertion portions 441 and 451, formed on both end portions of the top plate 34 in the Y direction, are inserted in the holes 442 and 452 of the right side plate 32 and the left side plate 31 respectively. Thereby the top plate 34 is positioned with the right side plate 32 and the left side plate 31 in the product front-back direction (X direction).

The bent portion 451a at the root of the insertion portion 451 of the top plate 34 includes a protruding portion 451b that is a bump generated by bending of the metal and protrudes in the direction of the bent line (X direction). In a state before the insertion portion 451 is inserted in the hole 452 (state where external force is not applied), the width of the protruding portion 451b in the X direction is larger than the size of the hole 452 of the left side plate 31 in the X direction. Because of the protruding portion 451b, the left side plate 31 is elastically deformed in the inserting direction (Z direction) and retracted when the insertion portion 451, which is a part of the top plate 34 having high rigidity, is inserted in the hole 452 of the left side plate 31 having low rigidity. Here both end portions of the protruding portion 451b of the insertion portion 451 in the X direction contact with the edge of the hole 452 in the X direction: in detail, contact with two inner peripheral surfaces of the hole 452 that face each other in the X direction. By this configuration, the left side plate 31 and the top plate 34 are positioned in the X direction without any gap, hence the solidity of the frame 30 can be enhanced. The positioning portion 44 of the right side plate 32 and the top plate 34 in the X direction, using the insertion portion 441 and the hole 442 is also as described above.

The front plate 33 and the right side plate 32 are positioned by the positioning portion 46, and the front plate 33 and the left side plate 31 are positioned by the positioning portion 47. When the insertion portions 461 and 471, formed on both end portions of the front plate 33 in the Y direction are inserted in the holes 462 and 472 of the right side plate 32 and the left side plate 31 respectively, the front plate 33 is positioned with the right side plate 132 and the left side plate 31 in the perpendicular direction (Z direction).

The bent part 471a at the root of the insertion portion 471 of the front plate 33 includes a protruding portion 471b that is a bump generated by bending of the metal and protrudes in the direction of the bent line (Z direction). In a state before the insertion portion 471 is inserted in the hole 472 (state where external force is not applied), the width of the protruding portion 471b in the Z direction is larger than the size of the hole 472 of the left side plate 31 in the Z direction. Because of the protruding portion 471b, the left side plate 31 is elastically deformed in the inserting direction (X direction) and retracted when the insertion portion 471, which is a part of the front plate 33 having high rigidity, is inserted in the hole 472 of the left side plate 31 having low rigidity. Here both end portions of the protruding portion 471b of the insertion portion 471 in the Z direction contact with the edge of the hole 472: in detail, two surfaces facing each other in the Z direction among the inner peripheral surfaces of the hole 472. By this configuration, the left side plate 31 and the front plate 33 are positioned in the Z direction without any gap, hence the solidity of the frame 30 can be increased. The positioning portion 46 of the right side plate 32 and the front plate 33 in the Z direction, using the insertion portion 461 and the hole 462, is also as described above.

Each of the above embodiments may be modified in various ways within the scope of the present disclosure. For example, in the example described in Embodiment 1, the insertion portion is disposed in the beam member having a larger plate thickness among the first side plate and the beam member. However, the insertion portion may be disposed in the first side plate having a smaller plate thickness. In this case, when the insertion portion having low rigidity is inserted in the hole having high rigidity, the widened portion including the protruding portion formed of the bent bump of the bent portion constituting the insertion portion is compressed, and contacts with the edge of the hole. This causes the insertion portion and the hole to be positioned without a gap. In the example described in Embodiment 2, the insertion portion is disposed in the first side plate having a smaller plate thickness among the first side plate and the beam member. However, the insertion portion may be disposed in the beam member having a larger plate thickness. In this case, when the insertion portion having high rigidity is inserted in the hole having low rigidity, the widened portion formed at the root portion of the protruding portion constituting the insertion portion elastically deforms the first side plate near the hole, and contacts with the edge of the hole. This causes the insertion portion and the hole to be positioned without a gap.

The present disclosure serves to enhance solidity of a frame of a conveying device for a recording material or an image forming apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-222680, filed Dec. 18, 2024, which is hereby incorporated by reference herein in its entirety.

What is claimed is:

1. A conveying device configured to convey a recording material, the conveying device comprising:
a conveying portion configured to convey the recording material;
a first side plate;
a second side plate facing the first side plate; and
a beam member mounted to the first side plate and the second side plate, a plate thickness of the beam member is different from a plate thickness of the first plate,
wherein one of the first side plate and the beam member includes a hole, and the other of the first side plate and the beam member includes an insertion portion inserted in the hole, the insertion portion includes a widened portion,
the hole and the insertion portion form a positioning portion that positions the first side plate and the beam member in a first direction,
the widened portion has a width in the first direction that increases from downstream to upstream in an inserting direction of the insertion portion into the hole, and
the widened portion includes a pair of end portions in the first direction that are in contact with an edge of the hole, in the first direction.

2. The conveying device according to claim 1, wherein a plate thickness of the one of the first side plate and the beam member is less than a plate thickness of the other of the first side plate and the beam member.

3. The conveying device according to claim 2, wherein in the positioning portion, the one of the first side plate and the beam member includes an elastically deformed portion that is elastically deformed in the inserting direction.

4. The conveying device according to claim 3, wherein:
the inserting direction is a direction toward an inner side of the conveying device; and
the elastically deformed portion of the one of the first side plate and the beam member is located on the inner side of the conveying device compared with the other of the first side plate and the beam member.

5. The conveying device according to claim 1, wherein a plate thickness of the one of the first side plate and the beam member is greater than a plate thickness of the other of the first side plate and the beam member.

6. The conveying device according to claim 1, wherein:
the other of the first side plate and the beam member is a sheet metal;
the insertion portion includes a bent portion, the first direction is a generatrix direction of the bent portion; and
at least a part of the bent portion is inserted in the hole.

7. The conveying device according to claim 6, wherein:
the widened portion includes a first protruding portion disposed in a first end of the bent portion in the generatrix direction, and includes a second protruding portion disposed in a second end of the bent portion in the generatrix direction; and
each of the first protruding portion and the second protruding portion protrudes in the generatrix direction, and is in contact with the edge of the hole in the first direction.

8. The conveying device according to claim 7, wherein each of the first protruding portion and the second protruding portion is a bent bump.

9. The conveying device according to claim 1 further comprising:
a biasing member configured to bias the one of the first side plate and the beam member toward the other of the first side plate and the beam member, in a direction parallel with the inserting direction.

10. The conveying device according to claim 1, wherein the beam member has a weight greater than a total of a weight of the first side plate and a weight of the second side plate.

11. An image forming system comprising:
a conveying device for a recording material, the conveying device including
a conveying portion configured to convey the recording material,
a first side plate,
a second side plate facing the first side plate, and
a beam member mounted to the first side plate and the second side plate, a plate thickness of the beam member is different from a plate thickness of the first plate, and
an image forming apparatus configured to form an image on the recording material,
wherein one of the first side plate and the beam member includes a hole, and the other of the first side plate and the beam member includes an insertion portion inserted in the hole, the insertion portion includes a widened portion,
the hole and the insertion portion form a positioning portion that positions the first side plate and the beam member in a first direction,
the widened portion has a width in the first direction that increases from downstream to upstream in an inserting direction of the insertion portion into the hole, and
the widened portion includes a pair of end portions in the first direction that are in contact with an edge of the hole, in the first direction.
